(19) United States
(12) Patent Application Publication
(10) Pub. No.: US 2009/0273478 A1
(43) Pub. Date: Nov. 5, 2009

(54) SLEEP ALERT WRISTBAND

(76) Inventor: Bradford Y. Mei, Charlestown, MA (US)

Correspondence Address: BURNS & LEVINSON, LLP, 125 SUMMER STREET, BOSTON, MA, 02110, US

(21) Appl. No.: 12/421,808

(22) Filed: Apr. 10, 2009

Related U.S. Application Data
(60) Provisional application No. 61/049,901, filed on May 2, 2008.

(51) Int. Cl. G08B 23/00

(52) U.S. Cl. 340/575

(57) ABSTRACT

A sleep alert device comprises a sensor adapted for sensing a physiological condition of a user indicative of falling asleep. The sensed physiological condition is compared to a predetermined threshold to determine if the user is falling asleep. An alarm is activated to stimulate and wake the user if the device determines that the user is falling asleep.

This application claims the priority date of Provisional Application Ser. No. 61/049,901, entitled SLEEP ALERT WRISTBAND, filed on May 2, 2008, which this application incorporates by reference in its entirety.

### BACKGROUND

The present teachings relate generally to stimulation devices and, more particularly, to methods and systems for staying awake.

Many people often find themselves very tired at times when they need to remain awake. Students, for example, although not limited thereto, often have the need to stay up late at night in order to study for tests or finish homework assignments and then must wake up early in the morning in order to get to school on time. If they live far away from school they may have to get up even earlier to accommodate for a long commute. In addition, they may have to be at school before classes start in order to finish homework or study. As a consequence, their ability to get a full night of sleep is hampered and they may be tired and fall asleep during the day.

The problems associated with staying awake are discussed in terms of students trying to stay awake in class. But the present teachings should not be limited to students in particular. In fact, any person who has the need to stay awake when tired is a potential user of this device. Potential users include, although not limited thereto, drivers, pilots, security guards, soldiers, fire watchers, students, etc.

If one were to simply sleep later in order to get a full night's rest, he or she would inevitably be late for work or class. In order to stay awake during the day, users may try the following: 1) ingesting caffeinated foods or drinks, which may be inappropriate for younger people and may have adverse health effects; 2) ingesting foods or drinks with high sugar content such as energy drinks, which only provide energy for a short while and also may have adverse health effects; 3) taking a shower or splashing cold water on one's face, which will only wake one up for a short period of time; or 4) increasing the heart rate by exercising, which will ultimately only make a person more tired.

Alarm clocks are used to wake a person up by making a loud noise. However, alarm clocks are not practical to carry around and may bother other people in the vicinity when they activate. While watch alarms are more practical, they may not be loud enough to wake a sleeping person and yet may still cause a disturbance to others when the alarm activates. Both alarm clocks and watch alarms activate based on a pre-selected alarm time, which does not help a person to remain awake. There remains the problem of trying to stay awake while, for example, sitting in class.

Another device includes two rings that are worn on two fingers next to each other. When the fingers touch each other, the rings connect an electrical circuit, activating an alarm. This device is intended to keep smokers awake while smoking a cigarette. This may be useful for drivers who drive overnight over long distances. However, the fingers wearing the two rings may not touch each other when the wearer falls asleep. The rings may also slip off the user's fingers by accident. In addition, the rings may be difficult to wear by drivers and others who work with their hands, since they may be uncomfortable or interfere with the activity.

Therefore, it would be beneficial to have a superior system and method for staying awake.

### SUMMARY

The needs set forth herein as well as further and other needs and advantages are addressed by the present embodiments, which illustrate solutions and advantages described below.

The system of the present embodiment includes, but is not limited to: a sensor adapted for sensing a physiological condition indicative of a user falling asleep; an alarm adapted for stimulating the user; and a comparator adapted for comparing the sensed physiological condition to a predetermined threshold; whereby the comparator activates the alarm if the sensed physiological condition substantially meets the predetermined threshold.

Other embodiments of the system and method are described in detail below and are also part of the present teachings.

For a better understanding of the present embodiments, together with other and further aspects thereof, reference is made to the accompanying drawings and detailed description, and its scope will be pointed out in the appended claims

### BRIEF DESCRIPTION OF THE DRAWINGS

FIG. 1 is a pictorial depicting one embodiment of the sleep alert wristband;

FIG. 2. is a pictorial depicting another embodiment of the sleep alert wristband;

FIG. 3 is a pictorial depicting use of the sleep alert wristband;

FIG. 4 is a block diagram showing data transfer between the sleep alert wristband and a computer; and

FIG. 5 is a flowchart showing one embodiment of the method of using a device for staying awake.

### DETAILED DESCRIPTION

The present teachings are described more fully hereinafter with reference to the accompanying drawings, in which the present embodiments are shown. The following description is presented for illustrative purposes only and the present teachings should not be limited to these embodiments.

The sleep alert wristband is a device that is worn by a user and measures one or more physiological condition to determine if the user is falling asleep. If it is determined that the user is falling asleep, an alarm is activated to stimulate and wake the user. For instance, although not limited thereto, the device may measure the user's pulse rate and when the user's pulse rate falls below a predetermined threshold, indicating that the user is falling asleep, the device may emit vibrations to stimulate the user. The device may also store and analyze a user's physiological condition over time. This may be accomplished in part by connecting the device to a computer running computer code which provides functionality such as data analysis, although not limited thereto.

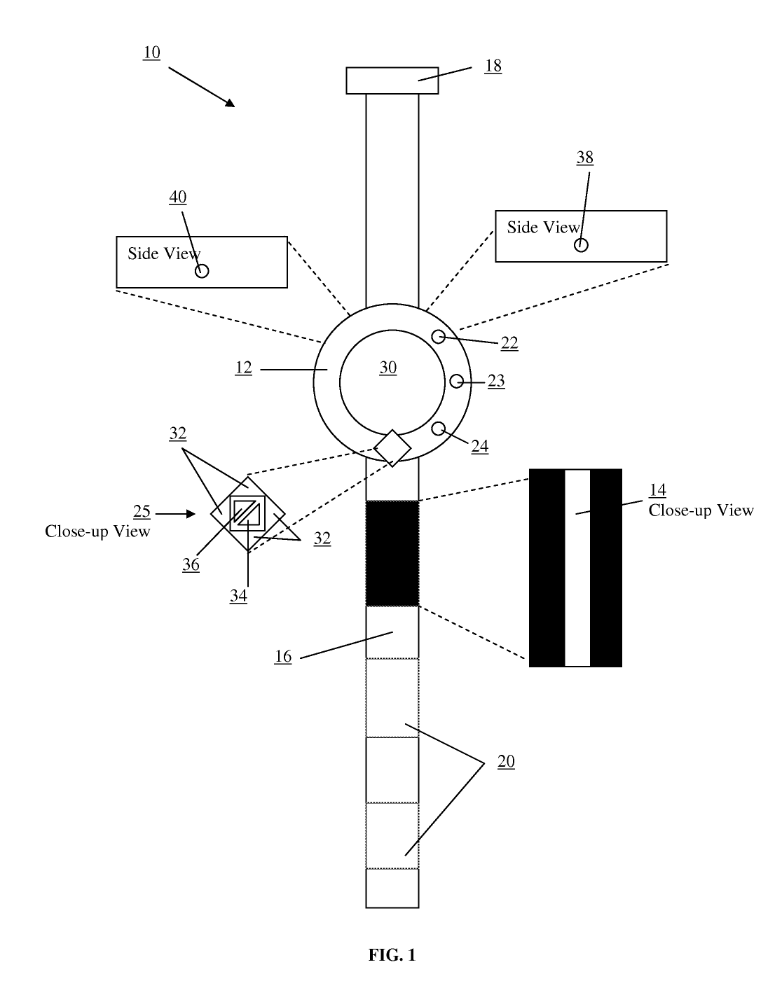

Referring now to FIG. 1, shown is a pictorial depicting one embodiment of the sleep alert wristband 10. The sleep alert wristband 10 may include a display module 12 and one or more sensors (e.g., skin contacts for pulse rate monitor, etc.) 14. The device may look similar to a wristwatch, with a display module 12 that displays information to the user such as current time, device settings, or any data sensed by the sensor 14.

The display module 12 may be mounted on a wrist strap 16, which may include a metal loop 18 and a loop and pile fastener 20 for securing the wrist strap 16 to the wrist of a user. In such a way, the wrist strap 16 may be wrapped around a user's wrist, inserted through the metal loop 18, and secure back to itself with the loop and pile fastener 20. It is appreciated that the sleep alert wristband 10 could be constructed in any number of different ways so long as the sensor 14 is in contact with the user, and it should not be limited this particular embodiment. For example, although not limited thereto, the sleep alert wristband 10 could instead be worn as a necklace. In an alternative embodiment, the sensor 14 may sense motion and would not need to directly contact the user's skin, but could be housed in the display module 12 itself, although not limited thereto.

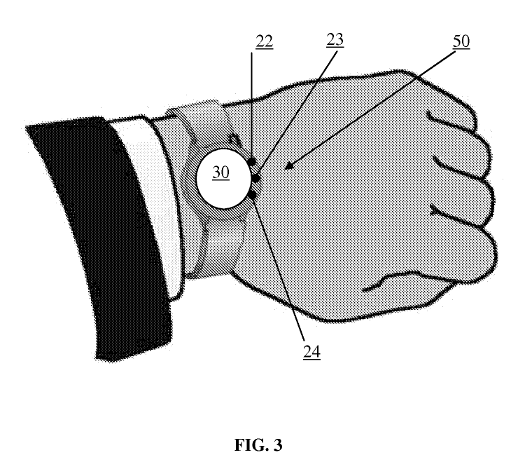

The display module 12 may be mounted on the wrist strap 16 and be generally located on the top of the user's wrist 50 (shown in FIG. 3), while the sensor 14 may be located on the underside of the wrist strap 16 and adjacent to the user's wrist, although not limited thereto. In one embodiment, the sensor 14 may include a pair of electrical skin contacts adapted to sense the resistivity of a user's skin and thereby enable the sleep alert wristband 10 to sense the user's pulse. The sensor 14 may alternatively include a motion sensor that is sensitive to the user's movement. In fact, any sensor that senses a physiological condition indicative of falling asleep may be used and the sleep alert wristband 10 should not be limited to these particular embodiments. For example, although not limited thereto, the sensor 14 may comprise a blood sugar monitor. The sensor 14 may connect to the display module 12 by any suitable means including, but not limited to, wires running through the wrist strap 16. Communication between the sensor 14 and the display module 12 may also be provided by any suitable wireless method.

The device may have control apparatus to navigate through a graphical user interface (GUI). For example, although not limited thereto, a multiplicity of control buttons (22-24, discussed below) as well as a navigation buttons 25 may control what is shown on the screen 30. The control buttons (22-24) may include an on/off button 22, a main window button 23 and a settings button 24, although not limited thereto. Navigation buttons 25 may include direction buttons 32, a back/cancel button 34 and a select button 36, although not limited thereto. In fact, any combination of buttons or other control apparatus to change the settings or navigate the GUI on the screen 30 may be used, and the sleep alert wristband 10 is not limited to this particular embodiment.

The device may further include electrical connections used to connect the sleep alert wristband 10 to other apparatus. For example, although not limited thereto, a battery charger port 38 electrical connection may provide the ability to connect a battery charger for charging an internal rechargeable battery or batteries. Furthermore, a data connection port 40 electrical connection may permit the sleep alert wristband 10 to connect to a computer for transferring data and modifying settings, although not limited thereto. The sleep alert wristband 10 may also connect to other apparatus wirelessly and it is not limited to this particular embodiment.

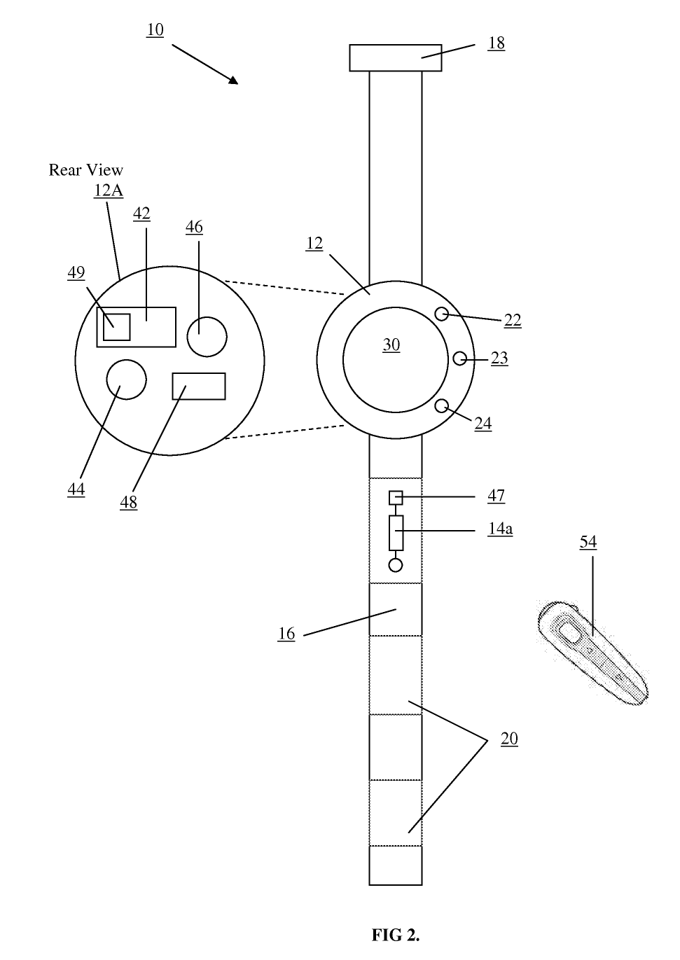

Referring now to FIG. 2., shown is a pictorial depicting another embodiment of the sleep alert wristband 10. Shown here, a motion sensor 14a may sense the user's lack of motion, a physiological condition indicative of a user falling asleep, and a comparator 42 may then compare the sensed physiological condition to a predetermined threshold. For example, the comparator 42 may compare the time period of the user's lack of motion to a maximum time threshold to determine if the user is falling asleep. In an alternative embodiment, although not limited thereto, the sensor 14 (shown in FIG. 1) may sense a user's pulse rate and the comparator 42 may compare the sensed pulse rate to a minimum pulse rate threshold to determine if the user is falling asleep.

An enlarged rear view 12a of the display module 12 is shown to include a comparator 42, a electronic storage device 44, a battery 46, and an alarm 48, although the sleep alert wristband 10 is not limited to this particular embodiment. The comparator 42 compares the physiological condition of the user, sensed by the motion sensor 14a (or some other sensor 14), to a predetermined threshold to determine if the user is falling asleep. The comparator 42 may include a timer 49 which times the period during which the user has a substantial lack of motion as sensed by the motion sensor 14a. The motion sensor 14a may also be located within the display module 12, although not limited thereto. The comparator 42 may compare any physiological condition indicative of falling asleep to a predetermined threshold and the present teachings are not limited to these particular embodiments. The predetermined threshold data may be stored an any suitable storage device, including the electronic storage device 44, although not limited thereto.

The timer 49 may also provide a delay to avoid false detections. When the comparator 42 indicates that the user is falling asleep, the timer 49 may begin a countdown for a predetermined period of time. Subsequent physiological condition that the user is awake (e.g., motion, an increased pulse rate, etc.) before the countdown expires may reset the timer 49 before an alarm 48 is activated. If the comparator 42 determines that the user is falling asleep for the duration of the timer's 49 countdown, the length of which may be variable and set based on user preferences such as 10 seconds to one minute, although not limited thereto, the alarm 48 may be activated by the comparator 42 to stimulate and wake up the user.

The alarm 48 may be an audio alarm, however a silent alarm may be preferred so as not to disturb any other people in the vicinity of the user. Alternatively, a wireless (e.g., Bluetooth®, etc.) ear piece 54 may be used to generate a quiet audio alarm and a transmitter 47 may send a wireless signal to the ear piece 54 to stimulate the user. If there is any change in the physiological condition of the user indicating that he or she is awake, as sensed by the motion sensor 14a (or other sensor 14), such as subsequent movement in the case of a motion detector, although not limited thereto, the comparator 42 may then deactivate the alarm.

The electronic storage device 44 may be used to record a user's physiological condition (e.g., pulse rate data, the time which no motion is detected, etc.) over time. This data may be used to determine the optimum settings for the predetermined thresholds, such as the timer 49 length and pulse rate threshold, although not limited thereto. For example, some users may have a lower resting pulse rate, and the comparator may automatically set a proper minimum pulse rate threshold for that user based on the historical pulse rate from the sensor 14. This may provide the most effective operation of the sleep alert wristband 10. Physiological condition information stored on the electronic storage device 44 may further be used for medical purposes such as the treatment of narcolepsy, although not limited thereto.

Referring now to FIG. 3, shown is a pictorial depicting use of the sleep alert wristband 10. The sleep alert wristband 10 is preferably wearable so that it can be carried with the user at all times. In this embodiment it is shown being worn on a user's wrist, but it is not limited to this particular embodiment. The on/off button 22 may allow the user to turn the screen 30 on and off. The main window button 23 may allow the user to access the main GUI window to view data such as pulse rate, time, and the date. The settings button 24 may allow the user to access the settings interface in order to change the date and time, the length of the timer 49, or any other settings. The user may also see his or her current physiological condition sensed by the sensor 14 and any past information stored on the electronic storage device 44. Direction buttons 32 (shown in FIG. 1), the select button 36, and the back/cancel button 34 allow the user to easily navigate the GUI. The screen 30 may also flash a visual alarm such as the words “WAKE UP” when the alarm is activated, although not limited thereto.

The sleep alert wristband 10, may be incorporated into traditional wristwatches so that it will always be available for use, providing the valuable functionality of waking the user up when they are falling asleep. To wear the sleep alert wristband 10, the screen 30 may be on top of the wrist 50 and the sensor 14 may touch the bottom of the wrist (not shown in FIG. 3). To turn on the sleep alert wristband 10, a user may hold down the on/off button 22 for three seconds, although not limited thereto. The same action may be performed to turn off the device, although not limited thereto.

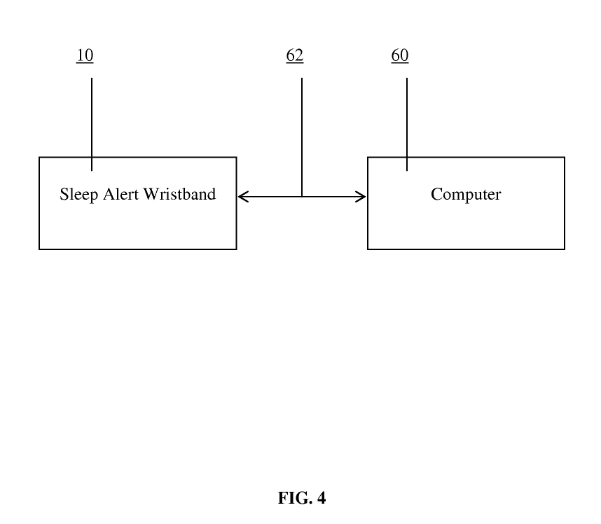

Referring now to FIG. 4, shown is a block diagram showing data transfer 62 between the sleep alert wristband 10 and a computer 60. A connection cord and a CD containing a computer program for storing and analyzing the physiological condition data may be distributed with the sleep alert wristband 10. This may allow the user to connect the device to a computer 10 to data transfer 62 between them. For example, the computer code on the computer 60 may receive the physiological condition data from the sleep alert wristband 10, suggest optimal predetermined thresholds, and set them on the device. The connection cord may also permit the battery 46 or batteries to be recharged by connecting the device to a power supply.

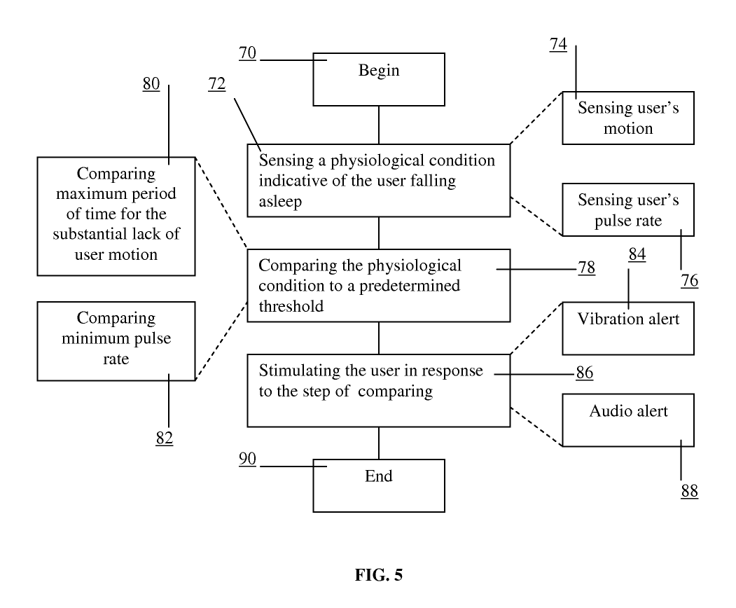

Referring now to FIG. 5, shown is a flowchart showing one embodiment of the method of using a device for staying awake. The method of using a device for keeping a user awake may comprise the steps of: sensing a physiological condition indicative of the user falling asleep 72; comparing the physiological condition to a predetermined threshold 78; and stimulating the user in response to the step of comparing 86. The step of sensing may include sensing the user's motion 74 and the step of comparing may have a predetermined threshold that includes a maximum period of time for the substantial lack of user motion 80. In the alternative, the step of sensing may include sensing the user's pulse rate 76 and the step of comparing may have a predetermined threshold that includes a minimum pulse rate 82. Finally, the step of stimulating may include a vibration alert 84 or an audio alert 88, although not limited thereto.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A device for keeping a user awake, comprising:
a sensor adapted for sensing a physiological condition indicative of the user falling asleep;
an alarm adapted for stimulating the user; and
a comparator adapted for comparing the sensed physiological condition to a predetermined threshold;
whereby the comparator activates the alarm if the sensed physiological condition substantially meets the predetermined threshold.

2. The device of claim 1, further comprising a securing member adapted for securing the device to the user.

3. The device of claim 2 wherein the securing member is adapted to secure to the user's wrist.

4. The device of claim 1 wherein the alarm is adapted to emit vibrations.

5. The device of claim 1 wherein the alarm is adapted to emit an audio alert.

6. The device of claim 1 wherein the alarm includes an ear piece adapted to emit an audio alert.

7. The device of claim 1 wherein:
the sensor includes a motion sensor; and
the comparator includes a timer and the predetermined threshold includes a maximum period of time for the substantial lack of user motion.

8. The device of claim 1 wherein the sensor includes a pulse rate sensor and the predetermined threshold includes a minimum pulse rate.

9. The device of claim 1 further comprising a display adapted for displaying the predetermined threshold.

10. The device of claim 1 further comprising a control apparatus adapted for adjusting the predetermined threshold.

11. The device of claim 1 further comprising a rechargeable battery to power the device.

12. The device of claim 11 further comprising an electrical connection adapted for charging the rechargeable battery.

13. The device of claim 1 further comprising an electronic storage device adapted for storing the sensed physiological condition.

14. The device of claim 13 further comprising an electrical connection adapted for communicating with a computer.

15. The device of claim 14 further comprising computer code, executed on the computer, adapted for analyzing the sensed physiological condition.

16. A method of using a device for keeping a user awake, comprising the steps of:
sensing a physiological condition indicative of the user falling asleep;
comparing the physiological condition to a predetermined threshold; and
stimulating the user in response to the step of comparing.

17. The method of claim 16 wherein the step of sensing includes sensing the user's motion and the step of comparing has a predetermined threshold that includes a maximum period of time for the substantial lack of the user's motion.

18. The method of claim 16 wherein the step of sensing includes sensing the user's pulse rate and the step of comparing has a predetermined threshold that includes a minimum pulse rate.

19. The method of claim 16 wherein the step of stimulating includes a vibration alert.

20. The method of claim 16 wherein the step of stimulating includes an audio alert.
